(19) United States
(12) Patent Application Publication
(10) Pub. No.: US 2026/0349644 A1
(43) Pub. Date: Nov. 5, 2026

(54) SCREEN CASTING METHOD, DEVICE, SYSTEM, AND STORAGE MEDIUM BASED ON A LINUX DEVICE

(71) Applicant: MediaTek Singapore Pte. Ltd., Singapore (SG)

(72) Inventor: Zhipeng DAI, Wuhan (CN)

(21) Appl. No.: 19/291,734

(22) Filed: Aug. 6, 2025

(30) Foreign Application Priority Data
Apr. 30, 2025 (CN) 202510571341.2

(51) Int. Cl. G06F 3/14

(52) U.S. Cl. CPC G06F 3/1454

(57) ABSTRACT

A screen casting method, device, system, and storage medium based on a Linux device. The method includes obtaining the cached data of the screen frame of the Linux device via a first process, wherein the first process includes KWin or Weston. The cached data is sent to a second process for encoding, with the second process based on the Gstreamer framework. The encoded data is then packaged into packets and sent to a second display device, allowing the second display device to show the Linux device's screen frame. This method enables the first process to obtain screen frame data, encode it via the second process, and then display the encoded data on a second display device, thus achieving screen casting from the Linux device to another device.

### CROSS REFERENCE TO RELATED APPLICATIONS

This application claims priority of China patent application No. 202510571341.2, filed Apr. 30, 2025, the entirety of which is incorporated by reference herein.

### TECHNICAL FIELD

The present disclosure relates to screen casting technology, and, in particular, it relates to a screen casting method, device, system, and storage medium based on Linux devices.

### BACKGROUND

Current mainstream screen casting protocols such as DLNA (Digital Living Network Alliance), Miracast, and AirPlay are primarily designed for casting content from mobile devices based on Android or iOS systems to other devices, such as televisions or PCs (running Windows, macOS, or GNU/Linux systems).

However, there is currently a lack of solutions for casting multimedia content displayed on devices based on Linux to other devices.

### BRIEF SUMMARY

An embodiment of the present disclosure provides a screen casting method, device, system, and storage medium based on Linux devices, for casting multimedia content displayed on a Linux-based device to other devices.

An embodiment of the present disclosure provides a method for screen casting based on a Linux device, comprising: obtaining cached data of screen frames of the Linux device via a first process, wherein the first process comprises KWin or Weston; sending the cached data to a second process via the first process, so that the second process encodes the cached data, wherein the second process is a process based on the Gstreamer framework; and packetizing the encoded cached data to generate a data packet, and sending the data packet to a display device, wherein the display device is able to display the screen frame of the Linux device based on the data packet.

In one embodiment, the first process includes a data acquisition sub-thread and a cache unification sub-thread, wherein the data acquisition sub-thread is KWin or Weston, and KWin or Weston is used to obtain the cached data of the screen frame from the Linux device, and the cache unification sub-thread is a process based on the Gstreamer framework; the step of obtaining the cached data of the screen frame from the Linux device via the first process comprises: obtaining the cached data of the screen frame from the Linux device via the data acquisition sub-thread; the step of sending the cached data to the second process via the first process comprises: pushing the cached data from the data acquisition sub-thread to the cache unification sub-thread; using inter-process communication, sending the cached data from the cache unification sub-thread to the second process.

In one embodiment, the cache unification sub-thread includes a cached data extraction plugin, a cached data type negotiation plugin, and a cached data transmission plugin; the step of sending the cached data to the second process via the cache unification sub-thread using inter-process communication comprises: extracting the cached data from the data acquisition sub-thread using the cached data extraction plugin; negotiating the cache data type using the cached data type negotiation plugin to obtain the cached data of a type supported by both the data acquisition sub-thread and the cache unification sub-thread; and extracting the cached data output by the cached data type negotiation plugin and sending the cached data to the second process using the cached data transmission plugin.

In one embodiment, the cached data extraction plugin is an appsrc plugin, the cached data type negotiation plugin is a caps plugin, and the cached data transmission plugin is an unixfdsink plugin.

In one embodiment, the second process includes a format conversion sub-thread and an encoding sub-thread, wherein the format conversion sub-thread is used to convert a format of the cached data, and the encoding sub-thread is used to encode the cached data after format conversion; the second process encoding the cached data includes: converting the format of the cached data via the format conversion sub-thread; and encoding the format-converted cached data via the encoding sub-thread.

In one embodiment, the format conversion sub-thread is a v4l2convert plugin, and the encoding sub-thread is an encode plugin; the step of converting the format of the cached data via the format conversion sub-thread includes: converting the cached data from a first format data stream to a second format data stream using the v4l2convert plugin; the step of encoding the format-converted cached data via the encoding sub-thread includes: encoding the second format data stream into a preset video codec standard stream using the encode plugin.

In one embodiment, obtaining input events on the display device via the second process, wherein the input events are commands for manipulating the screen frame of the Linux device shown on the display device; and in response to the first process detecting the input events, a display module responds to the input events.

An embodiment of the present disclosure provides a Linux device, comprising a display screen, a memory, and a processor, wherein the memory is coupled to the processor. The processor is configured to execute program instructions stored in the memory to implement the screen casting method based on a Linux device as described in the first aspect.

In addition, an embodiment of the present disclosure provides a computer-readable storage medium storing program instructions which, when executed by a processor, implement the screen casting method based on a Linux device as described in the first embodiment.

According to the above solution, cached data of screen frames of a Linux device is obtained via a first process, wherein the first process comprises KWin or Weston. The cached data is transmitted to a second process via the first process, such that the second process encodes the cached data, wherein the second process is a process based on the GStreamer framework. The encoded cached data is then encapsulated into data packets, which are transmitted to a display device. The display device is capable of displaying the screen content of the Linux device based on the data packets. Accordingly, the first process enables acquisition of screen frames from the Linux device, while the second process encodes the cached data of the screen frames. After the encoded data is transmitted to the display device, the screen content of the Linux device can be displayed on the display device, thereby realizing screen casting from a Linux device to another device.

It should be understood that the foregoing general description and the following detailed description are exemplary and explanatory only, and are not intended to limit the present application.

### BRIEF DESCRIPTION OF THE DRAWINGS

The present disclosure can be more fully understood by reading the subsequent detailed description and examples with references made to the accompanying drawings, wherein:

FIG. 1 shows a flow diagram illustrating an embodiment of the screen casting method based on a Linux device according to the present application.

FIG. 2 shows a schematic diagram of modules of a first process according to an embodiment of the present application.

FIG. 3 shows a schematic diagram of modules of a second process according to an embodiment of the present application.

FIG. 4 shows a schematic diagram illustrating interactions between processes in a Linux device according to an embodiment of the present application.

FIG. 5 shows a flow diagram illustrating another embodiment of the screen casting method according to the present application.

FIG. 6 shows a flow diagram illustrating yet another embodiment of the screen casting method according to the present application.

FIG. 7 shows a schematic diagram of a framework of an electronic device based on a Linux system according to an embodiment of the present application.

FIG. 8 shows a schematic diagram of a framework of a screen casting system according to an embodiment of the present application.

FIG. 9 shows a schematic diagram of a framework of a computer-readable storage medium according to an embodiment of the present application.

### DETAILED DESCRIPTION

The following description is made for the purpose of illustrating the general principles of the disclosure and should not be taken in a limiting sense. The scope of the disclosure is best determined by reference to the appended claims.

In this disclosure, the term "and/or" is merely used to describe an associative relationship between associated objects and indicates that three relationships may exist. For example, "A and/or B" can represent: A alone, both A and B together, or B alone. In addition, the character "/" generally indicates an "or" relationship between the associated objects. Moreover, the term "plurality" herein means two or more. Furthermore, the term "at least one" herein refers to any one or more combinations of two or more, for example, "at least one of A, B, and C" can represent any one or more elements selected from the set consisting of A, B, and C.

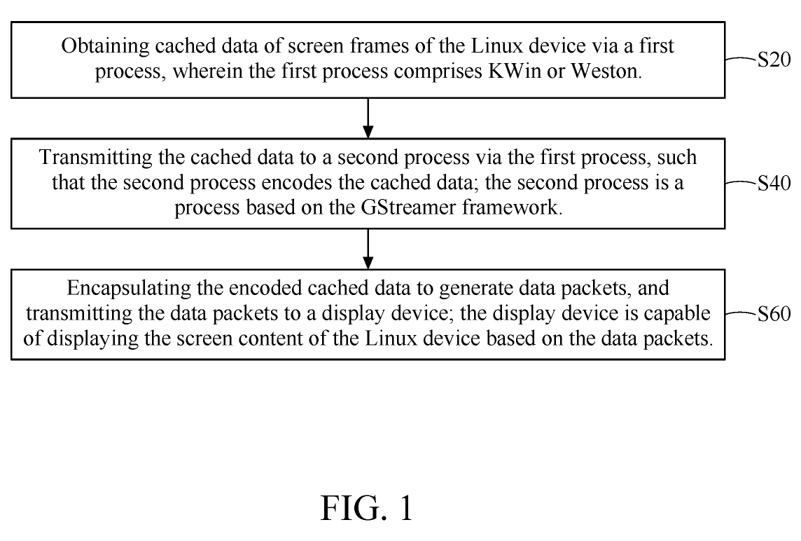

Referring to FIG. 1, FIG. 1 is a flow diagram illustrating an embodiment of the screen casting method based on a Linux device according to the present application. The screen casting method based on a Linux device comprises:

Step S20: Obtaining cached data of screen frames of the Linux device via a first process, wherein the first process comprises KWin or Weston.

Step S40: Transmitting the cached data to a second process via the first process, such that the second process encodes the cached data; the second process is a process based on the GStreamer framework.

Step S60: Encapsulating the encoded cached data to generate data packets, and transmitting the data packets to a display device; the display device is capable of displaying the screen content of the Linux device based on the data packets.

The screen casting method based on a Linux device provided in the present application can be applied to Linux devices, i.e., electronic devices based on the Linux operating system, such as Linux-based mobile phones, tablet computers, laptop computers, and the like. The display device may include tablets, laptops, projectors, mobile phones, and other devices, and may be based on the Android, iOS, Windows, or Linux operating systems. The screen casting method based on a Linux device, as provided in the present application, is capable of casting the screen content of a Linux device to a display device, such that the screen content of the Linux device is displayed on the display device.

According to the above solution, cached data of screen frames of a Linux device is obtained via a first process, wherein the first process includes KWin or Weston. The cached data is transmitted to a second process via the first process, such that the second process encodes the cached data, and the second process is a process based on the GStreamer framework. The encoded cached data is encapsulated into data packets, which are then transmitted to a display device. The display device is capable of displaying the screen content of the Linux device based on the data packets. Accordingly, the first process enables the acquisition of screen frames from the Linux device, and the second process is capable of encoding the cached data of the screen frames. After the encoded data is transmitted to the display device, the screen content of the Linux device can be displayed on the display device, thereby achieving screen casting from the Linux device to another device.

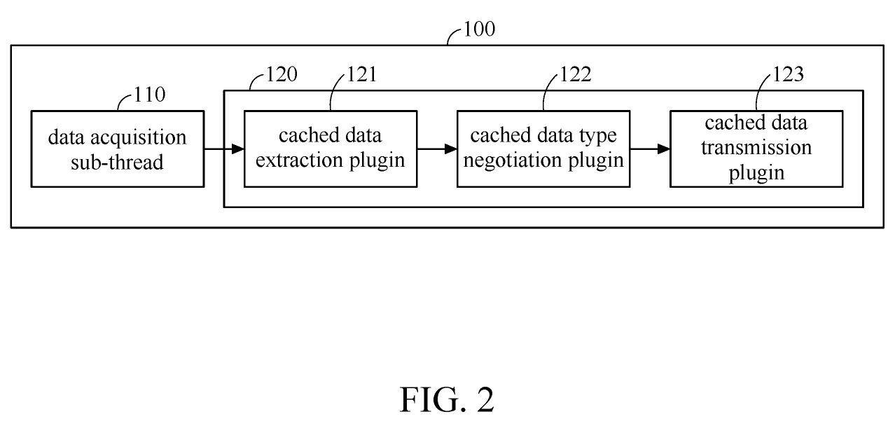

In some embodiments, referring to FIG. 2, FIG. 2 is a schematic diagram of modules of a first process according to an embodiment of the present application. The first process 100 includes a data acquisition sub-thread 110 and a buffer unification sub-thread 120. The data acquisition sub-thread 110 is KWin or Weston, which is used to obtain cached data of screen frames of the Linux device. The buffer unification sub-thread 120 is a process based on the GStreamer framework, such as a GStreamer recording pipeline. Since the first process 100 and the second process 200 use different types of buffers, the cached data of the first process 100 cannot be directly read by the second process 200. Therefore, the first process 100 further includes the buffer unification sub-thread 120. As both the buffer unification sub-thread 120 and the second process 200 are processes based on the GStreamer framework, the first process 100 is capable of converting the cached data output by KWin or Weston into a format that can be read by the second process 200 via the buffer unification sub-thread 120.

In some embodiments, Step S20 includes: obtaining cached data of screen frames of the Linux device via a data acquisition sub-thread 110.

In some embodiments, Step S40 includes: pushing the cached data to a buffer unification sub-thread 120 via the data acquisition sub-thread 110; and transmitting the cached data to a second process 200 via the buffer unification sub-thread 120 using inter-process communication.

With reference to the foregoing embodiments, the data acquisition sub-thread 110, i.e., KWin or Weston, first copies the cached data of screen frames from the display module of the Linux device via KWin or Weston. The cached data is then pushed to the buffer unification sub-thread 120 (e.g., a GStreamer recording pipeline). The buffer unification sub-thread 120 writes the cached data into a file descriptor unixfd created by the buffer unification sub-thread 120. Through inter-process communication, the second process 200 obtains the file descriptor unixfd and reads the cached data from it.

In some embodiments, the buffer unification sub-thread 120 includes a cached data extraction plugin 121, a cached data type negotiation plugin 122, and a cached data transmission plugin 123.

The cached data extraction plugin 121 (e.g., an appsrc plugin) is used to extract the cached data of screen frames from KWin. The cached data type negotiation plugin 122 is a caps plugin. The cached data transmission plugin 123 (e.g., a unixfdsink plugin) is used to create a file descriptor unixfd and write the cached data into the file descriptor unixfd, which is then sent to the second process 200 via inter-process communication.

In some embodiments, after the data acquisition sub-thread 110 copies the cached data of screen frames from the display module of the Linux device, the cached data is sequentially processed through the appsrc plugin, caps plugin, and unixfdsink plugin in GStreamer’s recording pipeline, and then written into the file descriptor unixfd created by the unixfdsink plugin. Through inter-process communication, the file descriptor is sent to the second process 200.

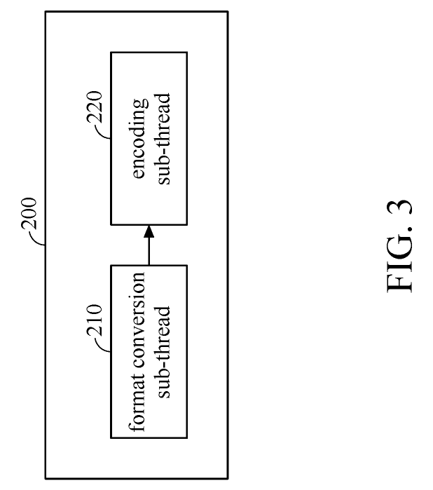

Referring to FIG. 3, FIG. 3 is a schematic diagram of the modules of the second process 200 according to an embodiment of the present application. In some embodiments, the second process 200 includes a format conversion sub-thread 210 and an encoding sub-thread 220. The format conversion sub-thread 210 is used to convert the format of the cached data, while the encoding sub-thread 220 is used to encode the cached data after format conversion.

In some embodiments, the encoding of the cached data by the second process 200 includes: converting the format of the cached data via the format conversion sub-thread 210; and encoding the format-converted cached data via the encoding sub-thread 220.

In some embodiments, the format conversion sub-thread 210 is a v4l2convert plugin, and the encoding sub-thread 220 is an encode plugin. In other embodiments, the format conversion sub-thread 210 may also be a GstVideoConvert plugin or other plugins used for format conversion, while the encoding sub-thread 220 may also be an X 264enc plugin or other plugins used for encoding.

In some embodiments, the format conversion of the cached data by the format conversion sub-thread 210 includes: converting the cached data from a first format data stream to a second format data stream through the v4l2convert plugin.

In some embodiments, the first format may be RGB format, and the second format may be YUV format. In other embodiments, the first format may be YUV format, and the second format may be RGB format. The first and second formats may also be other video data stream formats, such as BMP format.

In some embodiments, the encoding of the format-converted cached data by the encoding sub-thread 220 includes: encoding the second format data stream into a preset video codec standard bitstream through the encode plugin.

In some embodiments, the preset video codec standard bitstream refers to a video bitstream encoded and decoded according to a preset video codec standard, such as H.264 standard bitstream, H.263 standard bitstream, H.265 standard bitstream, and so on.

In some embodiments, the second process 200 further includes a cached data extraction sub-thread (not shown), a data parsing sub-thread (not shown), and a cached data transmission sub-thread (not shown). Exemplarily, the cached data extraction sub-thread may be a unifdsrc plugin, the data parsing sub-thread may be a parse plugin, and the cached data transmission sub-thread may be an appsink plugin. After the first process 100 sends the file descriptor to the second process 200 via inter-process communication, the second process 200 extracts the cached data from the file descriptor via the cached data extraction sub-thread, and sequentially processes the cached data via the format conversion sub-thread 210, the encoding sub-thread 220, the data parsing sub-thread, and the cached data transmission sub-thread to send out the encoded cached data.

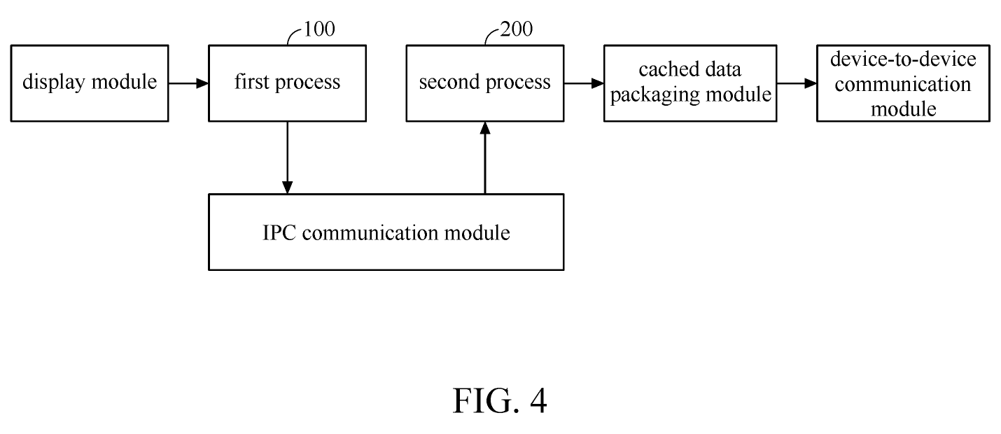

In some embodiments, referring to FIG. 4, FIG. 4 is a schematic diagram illustrating the interaction between processes in a Linux device according to an embodiment of the present application. First, the first process 100 obtains the cached data of screen frames from the display module and sends the cached data to the second process 200 through the IPC communication module. The specific process by which the first process 100 sends the cached data to the second process 200 through the IPC communication module can refer to the previous embodiments and will not be repeated here. After the second process 200 obtains the cached data, it encodes the cached data into different bitstreams, for example, encoding it into an H.264 bitstream. The cached data packaging module adds a packet header to each frame of screen frame data according to the protocol and encapsulates the data. The device-to-device communication module then sends the data packets to the display device.

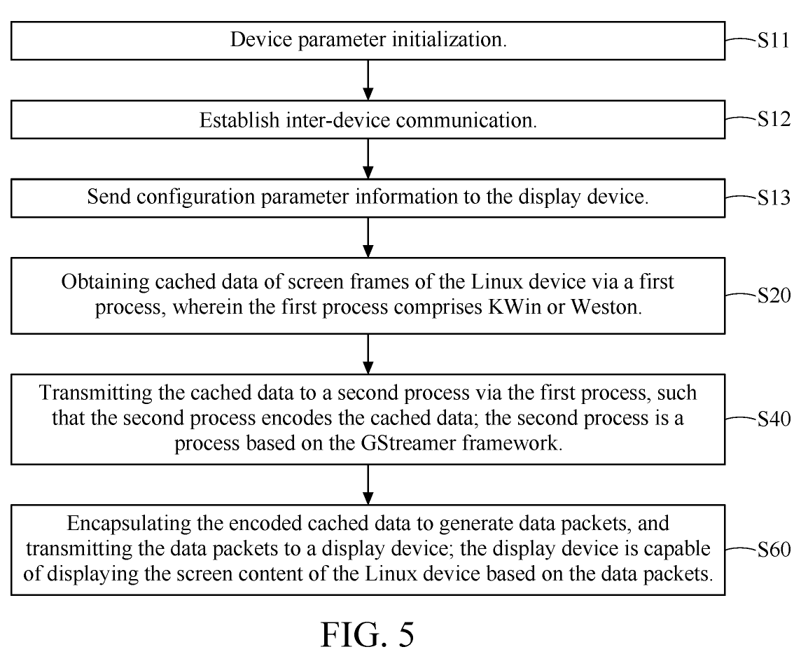

In some embodiments, referring to FIG. 5, FIG. 5 is a flowchart illustrating another embodiment of the screen casting method of the present application. The screen casting method further includes:

Step S11: Device parameter initialization.

For a Linux device, device parameter initialization includes setting the port for cross-device connection, selecting the data transmission method, and initializing parameters for data frame acquisition, transmission, format conversion, compression, encoding, and other data processing. In some embodiments, it further includes initializing an input device listening thread and registering the input device. The input device listening thread is used to monitor control operations on the Linux device performed on the display device, such as touch, swipe, and the like, which will be described in more detail in subsequent embodiments.

Correspondingly, for the display device, device parameter initialization includes setting the port for cross-device connection, selecting the data transmission method, initializing the data buffer, specifying the Linux device ID to connect to, and initializing the graphical display window, decoder parameters, and so on. In some embodiments, it also includes initializing an input device listening thread.

Step S12: Establish inter-device communication.

To enable inter-device communication between the Linux device and the display device, a network socket connection can be established using protocols such as adb, USB, TCP, IP, etc. Exemplarily, when the Linux device establishes a connection with the display device through the adb protocol, a local socket unixsocket is first created on the Linux device. After confirming the port used by the display device for cross-device connection, assume the port number is 27183, the local socket unixsocket on the Linux device side is reverse-proxied to the 27183 port of the display device using the adb port forwarding command, allowing the Linux device to access the display device.

Step S13: Send configuration parameter information to the display device.

The configuration parameter information is used to indicate some basic configurations of the Linux device, such as the window display width and height, bitstream encoding format, resolution, and other configuration details. This allows the display device to adaptively configure itself based on these parameters, so that it can properly decode and display the screen corresponding to the window configuration of the Linux device when receiving data packets from the Linux device.

In some embodiments, after the display device receives the data packet, it unpacks the packet according to the header information, retrieves the data frame, and copies it to the cache. The cached data is then decoded using a multimedia framework (e.g., ffmpeg), such as decoding an H.264 bitstream into a YUV bitstream. This decoded data is passed to the display window of the display device (e.g., SDL, X11, etc.) for display, thus enabling the display device to show the screen content of the Linux device.

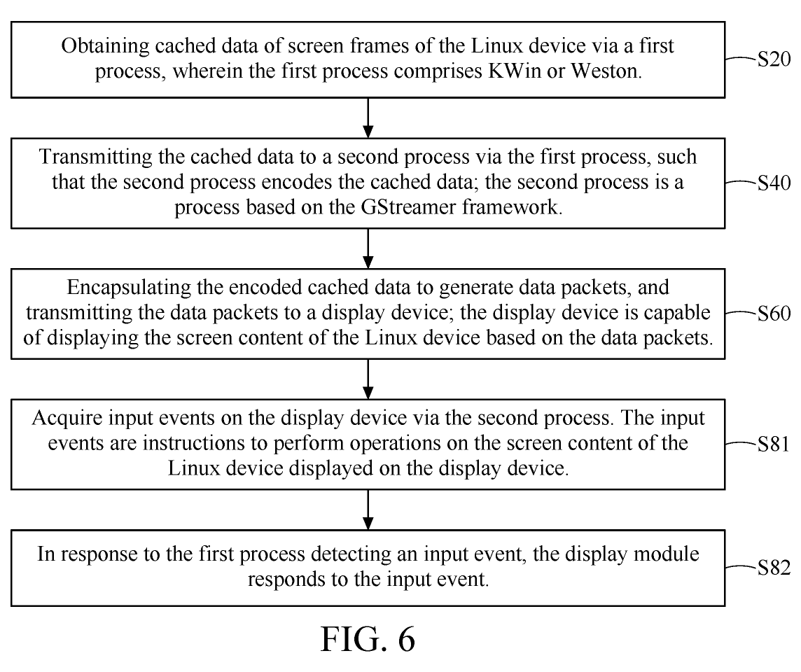

In some embodiments, referring to FIG. 6, FIG. 6 is a flowchart illustrating yet another embodiment of the screen casting method of the present application. The screen casting method further includes:

Step S81: Obtain input events on the display device via the second process 200. The input events are instructions to perform operations on the screen content of the Linux device displayed on the display device.

Input events on the display device refer to operations performed on the screen casting window using input devices (e.g., mouse, keyboard, stylus, touchscreen, etc.) on the display device, such as mouse clicks, swipes, and the like. The screen casting window refers to the window on the display device used to display the screen content of the Linux device. The screen casting window may cover a portion of the display area on the display device or may cover the entire display area. When the screen casting window covers a portion of the display area on the display device, only the input events directed at the screen casting window are captured by the second process 200, while input events directed at the remaining display areas will not be captured by the second process 200.

As in the previous embodiments, during the initialization of the device, an input device listening thread is created on the display device. The input device listening thread is used to monitor operations performed by input devices (e.g., mouse, keyboard, stylus, touchscreen, etc.) on the screen casting window, such as mouse clicks, swipes, etc., i.e., it listens for input events and obtains parameters like the coordinates of the input event. The coordinate parameters of the input event are used to indicate the target area affected by the input event. The input device listening thread writes the coordinate parameters and other information of the input event to the file descriptor corresponding to the socket.

During the device initialization, an input device listening thread is also created on the Linux device, and a virtual input device is registered. The listening thread on the Linux device retrieves input events from the file descriptor, simulates the operations of the input devices (e.g., mouse, keyboard, stylus, touchscreen, etc.) on the screen casting window on the display device, such as mouse clicks, swipes, etc., and injects these actions into the virtual input device.

Step S82: In response to the first process 100 detecting an input event, the display module responds to the input event.

In the above scheme, by obtaining input events on the display device and having the display module respond to these input events, the Linux device can be controlled through the display device.

It should be understood that Steps S20 to S82 do not necessarily follow a specific order. In some embodiments, Steps S20 to S82 can be performed in a different sequence.

Those skilled in the art will appreciate that in the specific embodiments of the method described above, the sequence of the steps does not imply a strict execution order nor impose any limitations on the implementation process. The specific execution sequence of the steps should be determined by their functions and the inherent logic involved.

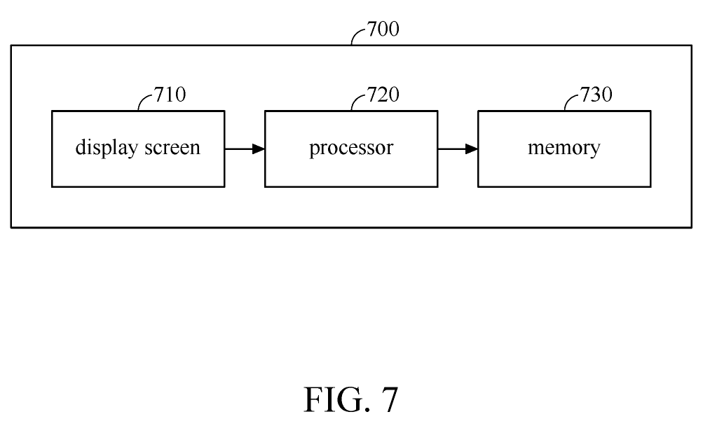

Referring to FIG. 7, FIG. 7 is a schematic diagram of an embodiment of a Linux device according to the present application. The Linux device 700 includes a display screen 710, a memory 730 coupled to a processor 720. The processor 720 is configured to execute program instructions stored in the memory 730 to implement the screen casting method based on a Linux device as described in any of the embodiments of the first aspect above.

In the above solution, the first process obtains the cached data of the screen frame from the Linux device, and the first process includes KWin or Weston. The first process sends the cached data to the second process, which encodes the cached data. The second process is based on the Gstreamer framework. The encoded cached data is then packetized into a data packet, which is sent to the display device. The display device can display the screen content of the Linux device based on the data packet. Therefore, the first process can obtain the screen frame of the Linux device, and via the second process, the cached data of the screen frame can be encoded. After sending the encoded data to the display device, the screen content of the Linux device can be displayed on the display device, thus enabling screen casting from the Linux device to another device.

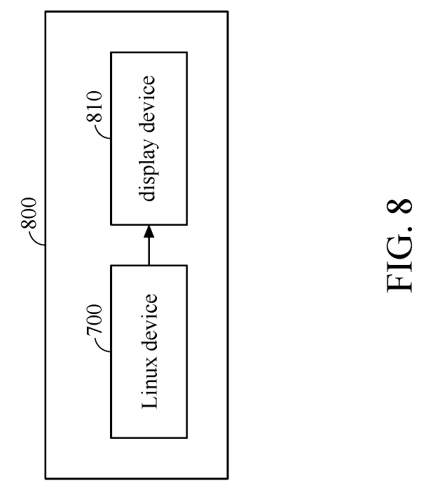

Referring to FIG. 8, FIG. 8 is a schematic diagram of an embodiment of the screen casting system according to the present application. The screen casting system 800 includes a Linux device 700 and a display device 810. The screen casting system 800 is used to display the screen content of the Linux device 700 on the display device 810. The Linux device is the Linux device 700 as described in the second aspect above.

In the above solution, the first process obtains the cached data of the screen frame from the Linux device, and the first process includes KWin or Weston. The first process sends the cached data to the second process, which encodes the cached data. The second process is based on the Gstreamer framework. The encoded cached data is then packetized into a data packet, which is sent to the display device. The display device can display the screen content of the Linux device based on the data packet. Therefore, the first process can obtain the screen frame from the Linux device, and via the second process, the cached data of the screen frame can be encoded. After sending the encoded data to the display device, the screen content of the Linux device can be displayed on the display device, thus enabling screen casting from the Linux device to another device.

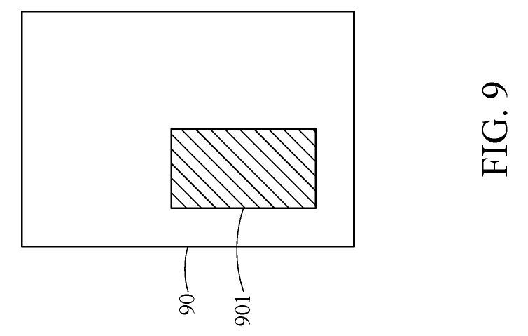

Referring to FIG. 9, FIG. 9 is a schematic diagram of an embodiment of a computer-readable storage medium according to the present application. The computer-readable storage medium 90 stores program instructions 901, and when executed by a processor, the program instructions 901 implement the screen casting method based on a Linux device as described in the first aspect above.

In the above solution, the first process obtains the cached data of the screen frame from the Linux device, and the first process includes KWin or Weston. The first process sends the cached data to the second process, which encodes the cached data. The second process is based on the Gstreamer framework. The encoded cached data is then packetized into a data packet, which is sent to the display device. The display device can display the screen content of the Linux device based on the data packet. Therefore, the first process can obtain the screen frame from the Linux device, and via the second process, the cached data of the screen frame can be encoded. After sending the encoded data to the display device, the screen content of the Linux device can be displayed on the display device, thus enabling screen casting from the Linux device to another device.

In some embodiments, the devices provided by the embodiments of the present disclosure, along with the functions or modules they contain, can be used to execute the methods described in the method embodiments above. The specific implementation can be referenced from the description of the method embodiments above, and for the sake of brevity, it will not be reiterated here.

The description of the various embodiments above tends to emphasize the differences between the embodiments, and their similarities or commonalities can be referenced mutually. For the sake of brevity, the similarities will not be restated here.

In several embodiments provided by the present application, it should be understood that the disclosed methods and devices can be implemented in other ways. For example, the device embodiments described above are merely illustrative. The division of modules or units is only one logical functional partition, and in actual implementation, a different division approach may be used. For instance, units or components can be combined or integrated into another system, or some features can be omitted or not executed. Another point is that the coupling or direct coupling or communication connection between the components shown or discussed may be through certain interfaces. The coupling or communication connection between devices or units can be indirect and can take the form of electrical, mechanical, or other forms.

Additionally, in various embodiments of the present application, each functional unit can be integrated into a single processing unit, or the units can physically exist separately. Two or more units can also be integrated into a single unit. The integrated units can be implemented in hardware form, or in the form of software functional units.

If the integrated unit is implemented in the form of software functional units and is sold or used as an independent product, it can be stored in a computer-readable storage medium. Based on this understanding, the technical solution of the present application, or the part that contributes to the existing technology, or all or part of the technical solution, can be embodied in the form of a software product. This computer software product is stored in a storage medium and includes several instructions that enable a computer device (which can be a personal computer, server, or network device, etc.) or processor to execute all or part of the steps of the methods in the various embodiments of the present application. The aforementioned storage medium includes: USB drives, external hard drives, read-only memory (ROM), random access memory (RAM), magnetic disks, optical disks, and other media that can store program codes.

If the technical solution of this application involves personal information, the products applying this solution will explicitly inform individuals of the personal information processing rules before handling such information and obtain the individual’s voluntary consent. If the technical solution of this application involves sensitive personal information, the products applying this solution will obtain separate consent from the individual before processing sensitive personal information and will simultaneously meet the requirements of "explicit consent." For example, at personal information collection devices, such as cameras, a clear and noticeable label will be set up to inform individuals that they have entered a personal information collection area and that their personal information will be collected. If an individual voluntarily enters the collection area, this will be regarded as consent to collect their personal information. Alternatively, on the device processing personal information, personal authorization will be obtained through obvious labels/information that explain the personal information processing rules, using methods such as pop-up messages or requesting the individual to upload their personal information themselves. The personal information processing rules may include details such as the personal information processor, the purpose of personal information processing, the processing method, and the types of personal information being processed.

What is claimed is:

1. A method for screen casting based on a Linux device, comprising:
obtaining cached data of a screen frame from the Linux device via a first process, wherein the first process includes KWin or Weston;
sending the cached data to a second process via the first process, so that the second process encodes the cached data, wherein the second process is a process based on the Gstreamer framework; and
packetizing the encoded cached data to generate a data packet, and sending the data packet to a display device, wherein the display device is able to display the screen frame of the Linux device based on the data packet.

2. The screen casting method as claimed in claim 1, wherein:
the first process includes a data acquisition sub-thread and a cache unification sub-thread, wherein the data acquisition sub-thread is KWin or Weston, and KWin or Weston is used to obtain the cached data of the screen frame from the Linux device, and the cache unification sub-thread is a process based on the Gstreamer framework;
the step of obtaining the cached data of the screen frame from the Linux device via the first process comprises:
obtaining the cached data of the screen frame from the Linux device via the data acquisition sub-thread;
the step of sending the cached data to the second process via the first process comprises:
pushing the cached data from the data acquisition sub-thread to the cache unification sub-thread; and
sending the cached data from the cache unification sub-thread to the second process, using inter-process communication.

3. The screen casting method as claimed in claim 2, wherein:
the cache unification sub-thread includes a cached data extraction plugin, a cached data type negotiation plugin, and a cached data transmission plugin;
the step of sending the cached data to the second process via the cache unification sub-thread using inter-process communication comprises:
extracting the cached data from the data acquisition sub-thread using the cached data extraction plugin;
negotiating the cache data type using the cached data type negotiation plugin to obtain the cached data of a type supported by both the data acquisition sub-thread and the cache unification sub-thread; and
extracting the cached data output by the cached data type negotiation plugin and sending the cached data to the second process using the cached data transmission plugin.

4. The screen casting method as claimed in claim 3, wherein
the cached data extraction plugin is an appsrc plugin, the cached data type negotiation plugin is a caps plugin, and the cached data transmission plugin is an unixfdsink plugin.

5. The screen casting method as claimed in claim 1, wherein
the second process includes a format conversion sub-thread and an encoding sub-thread, wherein the format conversion sub-thread is used to convert a format of the cached data, and the encoding sub-thread is used to encode the cached data after format conversion;
the second process encoding the cached data includes:
converting the format of the cached data via the format conversion sub-thread; and
encoding the format-converted cached data via the encoding sub-thread.

6. The screen casting method as claimed in claim 5, wherein
the format conversion sub-thread is a v4l2convert plugin, and the encoding sub-thread is an encode plugin;
the step of converting the format of the cached data via the format conversion sub-thread includes:
converting the cached data from a first format data stream to a second format data stream using the v4l2convert plugin;
the step of encoding the format-converted cached data via the encoding sub-thread includes:
encoding the second format data stream into a preset video codec standard stream using the encode plugin.

7. The screen casting method as claimed in claim 1, further comprising:
obtaining input events on the display device via the second process, wherein the input events are commands for manipulating the screen frame of the Linux device shown on the display device; and
in response to the first process detecting the input events, a display module responds to the input events.

8. A Linux device, comprising a display screen, a memory, and a processor, wherein the memory is coupled to the processor, and the processor is configured to execute program instructions stored in the memory to implement the screen casting method based on the Linux device described in claim 1.

9. A screen casting system, comprising a Linux device and a display device, wherein the screen casting system is configured to display a screen frame of the Linux device on the display device, and the Linux device is the Linux device described in claim 8.

10. A computer-readable storage medium storing program instructions, wherein the program instructions, when executed by a processor, implement the screen casting method based on the Linux device described in claim 1.
